(19) United States
(12) Patent Application Publication
(10) Pub. No.: US 2025/0336000 A1
(43) Pub. Date: Oct. 30, 2025

(54) SYSTEMS AND METHODS FOR GENERATING QUOTES FOR CIRCLE OF PROTECTION INSURANCE PLANS

(71) Applicant: Allstate Insurance Company, Northbrook, IL (US)

(72) Inventor: Prashant Mehrotra, Northbrook, IL (US)

(21) Appl. No.: 18/647,225

(22) Filed: Apr. 26, 2024

(51) Int. Cl. G06Q 40/08

(52) U.S. Cl. CPC G06Q 40/08

(57) ABSTRACT

Systems and methods for automatically generating quotes for a circle of protection insurance plan include identifying a type of device of network-connected device connected to a central connection hub based on information from a global device repository communicatively coupled to the central connection hub, determining, using a machine learning-based determination module and one or more connectivity rules, whether the network-connected device is eligible for the circle of protection insurance plan and generating, using an underwriting module and based on a determination that the network-connected device is eligible for the circle of protection insurance plan, a quote to update the circle of protection plan to include the network-connected device.

### TECHNICAL FIELD

The present disclosure relates to systems and methods for generating insurance quotes and, in particular, systems and methods for automatically generating quotes to update a circle of protection insurance plan.

### BACKGROUND

In the modern era, proliferation of network-connected devices such as belong to an Internet-of-Things (IoT) in both household and business environments has been significant. These devices have become integral to daily operations, increasing the need for comprehensive insurance coverage. However, traditional methods for obtaining insurance for such devices involves a laborious process of a user manually identifying and registering each device, followed by seeking an individual insurance quote for each device. Accordingly, a need exists for an advanced system that offers an improved and more streamlined method for generating and managing insurance plans for network-connected devices reducing user involvement.

### BRIEF SUMMARY

According to the subject matter of the present disclosure, a system may include a central connection hub configured to be communicatively coupled to one or more network-connected devices associated with a controlling user entity, an automated discovery tool, a global device repository, one or more memory components, and one or more processors, with the central connection hub, the automated discovery tool, the global device repository, and the one or more memory units being communicatively coupled to the one or more processors. The system may further include machine readable instructions stored in the one or more memory components that cause the system to perform at least the following when executed by the one or more processors: interface with a network-connected device via the central connection hub based on connection of the network-connected device to the central connection hub; identify a type of device of the network-connected device connected to the central connection hub automatically based on information from the global device repository; and determine, using a machine learning-based determination module and one or more connectivity rules, whether the network-connected device is eligible for a circle of protection insurance plan for the one or more of network-connected devices associated with the controlling user entity. The machine readable instructions may further cause the system to: generate, using an underwriting module and based on a determination that the network-connected device is eligible for the circle of protection insurance plan, a quote to update the circle of protection plan to include the network-connected device; display, via a user interface of a mobile device of the controlling user entity communicatively coupled to the automated discovery tool, the quote and a prompt to accept the quote; and upon acceptance of the prompt to accept the quote on the user interface of the mobile device, add the network-connected device to the circle of protection plan. The network-connected device becomes one of the one or more network-connected devices associated with the controlling user entity.

According to another embodiment of the disclosure, a system may include a central connection hub configured to be communicatively coupled to one or more network-connected devices associated with a controlling user entity. The controlling user entity is one of a household or business. The system may further include an automated discovery tool, a global device repository, one or more memory components, and one or more processors, with the central connection hub, the automated discovery tool, the global device repository, and the one or more memory units being communicatively coupled to the one or more processors. The system may further include machine readable instructions stored in the one or more memory components that cause the system to perform at least the following when executed by the one or more processors: interface with a network-connected device via the central connection hub based on connection of the network-connected device to the central connection hub; identify a type of device of the network-connected device connected to the central connection hub automatically based on information from the global device repository; determine, using a machine learning-based determination module and one or more connectivity rules, whether the network-connected device is eligible for a circle of protection insurance plan for the one or more of network-connected devices associated with the controlling user entity; and generate, using an underwriting module and based on a determination that the network-connected device is eligible for the circle of protection insurance plan, a quote to update the circle of protection plan to include the network-connected device. The machine readable instructions may further cause the system to: display, via a user interface of a mobile device of the controlling user entity communicatively coupled to the automated discovery tool, the quote and a prompt to accept the quote; upon acceptance of the prompt to accept the quote on the user interface of the mobile device, add the network-connected device to the circle of protection plan, wherein the network-connected device becomes one of the one or more network-connected devices associated with the controlling user entity; and monitor a monitored condition of each of the one or more network-connected devices in real-time while each network-connected device is connected to the central connection hub.

In yet another embodiment, a method may involve, via a central connection hub configured to be communicatively coupled to one or more network-connected devices associated with a controlling user entity, interfacing with a network-connected device based on connection of the network-connected device to the central connection hub; identifying a type of device of the network-connected device connected to the central connection hub automatically based on information from a global device repository communicatively coupled to the central connection hub; and determining, using a machine learning-based determination module and one or more connectivity rules, whether the network-connected device is eligible for a circle of protection insurance plan for the one or more of network-connected devices associated with the controlling user entity. The method may further include generating, using an underwriting module and based on a determination that the network-connected device is eligible for the circle of protection insurance plan, a quote to update the circle of protection plan to include the network-connected device; displaying, via a user interface of a mobile device of the controlling user entity communicatively coupled to the automated discovery tool, the quote and a prompt to accept the quote; and upon acceptance of the prompt to accept the quote on the user interface of the mobile device, and adding the network-connected device to the circle of protection plan. The network-connected device becomes one of the one or more network-connected devices associated with the controlling user entity.

Although the concepts of the present disclosure are described herein with primary reference to a system for automatically generating a circle of protection insurance plan for a number of network-connected devices, it is contemplated that the concepts will enjoy applicability to any setting for purposes of management and/or monitoring of network-connected devices.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an automated quote generation environment according to one or more embodiments shown and described herein;

FIG. 2 illustrates a flowchart process for use with the automated quote generation environment of FIG. 1, according to one or more embodiments shown and described herein;

FIG. 3 illustrates a computer implemented system including a system for use with the process flow of FIG. 2 and the automated quote generation environment of FIG. 1, according to one or more embodiments shown and described herein.

### DETAILED DESCRIPTION

In embodiments described herein, systems and methods for automatically generating quotes for circle of protection insurance plans include a central connection hub, automated discovery tools, a global device repository, and machine learning-based determination modules to streamline the process of insuring network-connected devices to be covered under said circle of protection insurance plans. The systems and methods described herein improve and simplify the insurance process for a user by such frictionless automation per control schemes as described herein reducing user involvement, and further ensure that the selected circle of protection plan is responsive to and more accurately capturing an ever-changing landscape of network-connected devices. A system as described herein may be configured to combine a central connection hub, an automated discovery mechanism such an automated discovery tool, machine learning based prediction and estimation, and an IoT data repository such as a global device repository to automatically retrieve device information to determine eligibility for and/or update of a circle of protection insurance plan for properties with network connected devices. The system may further be configured to estimate quotes for addition to the plan and/or generate an updated plan. In embodiments, the system may further automatically generate warning alerts associated with said network connected devices.

As should be appreciated, other systems require significant user involvement in identifying and registering each device, and in seeking and comparing insurance quotes, resulting in a more friction-heavy environment requiring the significant manual user involvement. The systems and methods described herein provide a more frictionless control scheme to reduce or prevent chances of leaving devices uninsured and/or inadequately covered. The systems and methods described herein further utilize real-time data and advanced predictive models to accurately assess the risk and condition of network-connected devices, leading to precise and fair insurance plan pricing.

The disclosed systems and methods offer dynamic updating of insurance coverage in response to changes in a network-connected device environment by providing an automated system designed to streamline the process of generating and managing insurance plans for network-connected devices such as in an IoT environment in of a controlling user such as a household or business. The systems and methods described herein minimize user involvement, accurately assess device conditions and risks using real-time and historical data, and dynamically update insurance plans as a network environment changes.

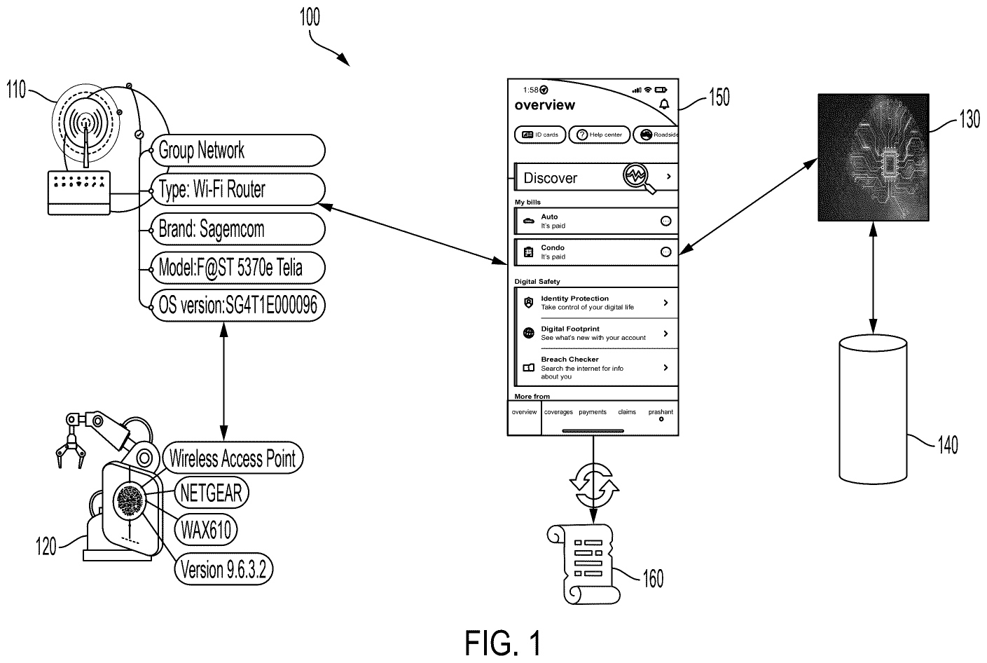

Referring now to FIG. 1, an automated quote generation environment 100 is depicted. The environment 100 includes a central connection hub 110, a global device repository 120, a machine learning-based determination module 130, an underwriting module 140, and an automated discovery tool 150. In embodiments, the central connection hub 110 may be a router, and/or the automated discovery tool 150 may be an artificial intelligence (AI) based software application downloadable on a computing device of a user, such as a smart mobile device. In other embodiments, the global device repository may communicate directly with the automated discovery tool 150. As will be described in additional detail herein, the various components of the environment 100 may be synergistically integrated and/or communicatively coupled to allow the environment 100 to automatically generate a quote 160 for a circle of protection insurance plan to insure network-connected devices within the environment 100.

For example, each component of the environment 100 depicted in FIG. 1 operates in a cohesive manner to generate the quote 160 for and/or to update the circle of protection insurance plan based on the various network-connected devices within the environment. When a network-connected device is connected to the central connection hub 110, the automated discovery tool 150 identifies the device and gathers necessary data, supplemented by the global device repository 120. This data is analyzed by the determination module 130 using machine learning techniques to assess the condition and insurance eligibility of the device. The underwriting module 140 then uses this analysis to generate a tailored insurance quote, which is displayed to a user through a user interface. User interactions with the interface allow for dynamic updating of insurance plans as new devices are added or existing devices' conditions change. Operation of the various components of the environment 100 will now be described in additional detail herein.

Referring still to FIG. 1, the central connection hub 110 may act as a primary interface for a plurality of network-connected devices within the environment 100. For example, the central connection hub 110 may be configured to be communicatively coupled with each of the network-connected devices in the environment 100. In these embodiments, the central connection hub 110 may be any hardware device or system capable of identifying devices within the environment 100, such as a WiFi router, network gateway, smart home hub, IoT gateway, broadband modem, or any other similar system through which data from network-connected devices may be collected and managed.

In operation, the central connection hub 110 may be configured to automatically detect and interface with network-connected devices in the environment 100. In these embodiments, the central connection hub 110 may be communicatively coupled to the global device repository 120, which may be configured to provide identifying information about each of the network-connected devices to the central connection hub 110.

For example, when a network-connected device joins the environment 100, the central connection hub 110 may detect its presence using a unique device identifier, such as media access control (MAC) address or internet protocol (IP) address. Once the central connection hub 110 has detected the network-connected device, the central connection hub 110 may collect additional device data, such as manufacturer details, model number, and other device-specific information.

Referring still to FIG. 1, the device data collected by the central connection hub 110 may be relayed to the global device repository 120. In these embodiments, the global device repository 120 may be a database containing detailed information regarding a variety of network-connected devices. The global device repository 120 may be configured to process the device data conveyed by the central connection hub 110 and cross-reference the device data with detailed information stored in the global device repository 120. By comparing the device data (e.g., unique identifiers, etc.) providing by the central connection hub 110 to the information stored in the global device repository 120, the global device repository 120 may accurately determine a specific type and model of the network-connected device. The global device repository 120 may then relay information related to the type and/or model of each of the network-connected devices back to the central connection hub 110 for further processing, as will be described in additional detail herein.

In the embodiments described herein, it should be appreciated that the network-connected devices may be any devices capable of connecting to the environment 100 of FIG. 1. For example, the network-connected devices may include smart home devices (e.g., thermostats, lighting systems, security cameras, locks), entertainment devices (e.g., televisions, streaming devices, gaming consoles), personal devices (e.g., smart phones, tablets, watches, etc.), home appliances (e.g., refrigerators, ovens, washing machines, etc.), computing equipment (e.g., computers, laptops, printers, etc.) and/or other IoT systems (e.g., home energy monitors, irrigation systems, health monitoring devices, electronic cars, solar panels, etc.).

Furthermore, it should be appreciated that each of the network-connected devices described herein may be associated with a controlling user entity, which may refer to the individual, group, and/or organization that has control over the environment 100 and each of the network-connected devices connected to the environment 100. In these embodiments, the controlling user entity may be responsible for managing each of the network-connected devices and making decisions regarding their insurance coverage. For example, in the embodiments described herein, the controlling user entities may include a household and/or family, business and/or corporation, educational institution, government agency, community center, or any other similar entity.

Referring still to FIG. 1, once the global device repository 120 has provided the type and/or model information of each of the network-connected devices to the central connection hub 110, the central connection hub 110 may relay the information to the automated discovery tool 150. In these embodiments, the automated discovery tool 150 may utilize the device data provided by the central connection hub 110 to categorize network-connected devices, determine an operational status of each of the network-connected devices, and/or prepare the device data for analysis by the determination module 130, as will be described in additional detail herein. Furthermore, the automated discovery tool 150 may be configured to interface with a user interface of at least one of the network-connected devices to display quotes and/or prompts generated within the environment 100.

With the device data prepared, the automated discovery tool 150 may relay the device data to the determination module 130 for further analysis. In these embodiments, the determination module 130 may be a machine learning-based determination module that uses advanced machine learning algorithms to analyze the device data provided by the central connection hub 110 and determine the eligibility of each of the network-connected devices for a circle of protection insurance plan. In determining the eligibility of each of the network-connected devices, the determination module 130 may assess a condition and/or risk factors associated with each of the network-connected devices, and may then provide this information to the underwriting module 140, as will be described in additional detail herein, and may further utilize one or more rules as described herein for the determination. Such business rules may also be referenced as connectivity rules herein and may include detection of patterns with respect to user registration of the device and/or connection time of the device (i.e., the device has been connected overnight or for another pre-defined period of time).

In these embodiments, various machine learning processes may be employed by the determination module 130 to determine the eligibility of each of the network-connected devices for insurance coverage. For example, in some embodiments, the determination module 130 may utilize a supervised learning process, which may involve training the determination module on a labeled dataset. In these embodiments, the determination module 130 may be trained with historical data on a plurality of devices, including make, model, usage patterns, failure rates, and previous insurance claims. The determination module 130 may then be trained to associate the historical data with whether each of the plurality of devices were accepted or rejected for insurance coverage, and apply this training to new network-connected devices that enter the environment 100.

In other embodiments, the determination module 130 may utilize an unsupervised learning process. For example, in these embodiments, the determination module 130 may be configured to group devices based on device features (e.g., usage frequency, age, repair history, etc.) and may flag particular device groups based on a risk condition. The risk condition may then be analyzed to determine the eligibility of each network-connected device within the device group for insurance coverage.

It should be further appreciated that the determination module 130 may utilize any machine learning process that may allow the determination module 130 to accurately determine eligibility of each of the network-connected devices within the environment 100. For example, the determination module 130 may further utilize natural language processing (NLP), predictive analysis, anomaly detection, neural networks, or any other similar machine learning-based process without departing from the scope of the present disclosure.

Referring still to FIG. 1, the determination module 130 may further interface with the underwriting module 140 to generate the quote 160 for the circle of protection insurance plan for each of the network-connected devices that are eligible for protection. In these embodiments, the underwriting module 140 may utilize condition assessments and risk evaluations to calculate insurance quotes for each of the eligible network-connected devices, and may provide the quote 160 to a user for purchasing.

In these embodiments, the underwriting module 140 may be further configured to update the circle of protection insurance plan based on the quote 160 by monitoring a condition of each of the network-connected devices within the environment 100. As should be appreciated, various aspects of a device's condition may impact insurance considerations. For example, in the embodiments described herein, the underwriting module 140 may consider an age of each of the network-connected devices, a physical condition, usage patterns, repair and/or maintenance records, software updates, environmental conditions, energy consumption patterns, functional performance, connectivity and network behavior, and/or any other similar condition of each of the network-connected devices.

Based on the condition of each of the network-connected devices, the underwriting module 140 may be capable of dynamically adjusting and updating the quote 160 for a network-connected device for coverage by the circle of protection insurance plan. For example, if the condition of a network-connected device (or multiple network-connected devices) deteriorates, the underwriting module 140 may review the insurance plan under the circle of protection plan for the device, which may lead to an updated quote 160 and/or insurance premium. In contrast, when a network-connected device is well-maintained and exhibits consistent performance, the underwriting module 140 may provide more favorable insurance quotes and/or discounts, thereby encouraging proactive device management.

Referring still to FIG. 1, the environment 100 may be further configured to predict maintenance requirements of each of the network-connected devices by utilizing a combination of real-time data and historical data related to each of the network-connected devices. For example, in these embodiments, the central connection hub 110 may continuously monitor each of the network-connected devices and provide monitored condition data to the determination module 130. The determination module 130 may then utilize various machine learning techniques, as described herein, to predict when the network-connected devices may require maintenance.

For example, the central connection hub 110 may be configured to continuously monitor real time data, including performance levels, error rates, usage patterns, and/or environmental conditions, on each of the network-connected devices and provide the real time data to the determination module 130. This real time data may be in addition to historical data (e.g., maintenance records, performance issues, etc.) provided to the determination module 130 when the initial circle of protection insurance quote is generated. The determination module 130 may then, in real time, conduct data analysis to identify network-connected devices that may require maintenance. In embodiments, the determination module 130 may transmit a notification of such recommended maintenance to a graphical user interface (GUI) of a mobile device of a controlling user entity communicatively coupled to the automated discovery tool 150.

The determination module 130 may utilize pattern detection and/or anomaly detection methods to identify changes and/or deviations in performance of each of the network-connected devices. For example, the determination module 130 may identify that a network-connected device has recently begun consuming a larger amount of power than usual, or is experiencing increased error rates. These changes and/or deviations may be used along with the historical data of each of the network-connected devices to predict when a particular network-connected device is likely to require maintenance.

In making the prediction, the determination module 130 may further conduct a risk assessment to assess the risk that a particular network-connected device may fail. In these embodiments, understanding a typical life cycle and/or failure mode of a particular type of network-connected device may allow the determination module 130 to generate a more accurate prediction regarding the need for maintenance on a particular network-connected device.

Referring still to FIG. 1, in the event the determination module 130 determines that at least one of the network-connected devices requires maintenance, the environment 100 may generate an alert to a user indicating that maintenance on the network-connected device is required. In some embodiments, the alert may further include recommendations for performing the maintenance, including the timeline under which the maintenance should be performed (e.g., how long the device may continue to operate prior to failure). Furthermore, in circumstances in which the maintenance involves an insurance claim event, the environment 100 may further aid in generating the insurance claim for the user so that maintenance on the network-connected device may be performed.

It should be appreciated that, in the embodiments described herein, historical data may provide device context and trends over time, while real-time data offers immediate insights into the current state of the network-connected devices. Together, they enable the environment 100, and more particularly, the determination module 130, to make informed decisions about maintenance needs, risk assessment for insurance purposes, and predictions about future performance or potential failures.

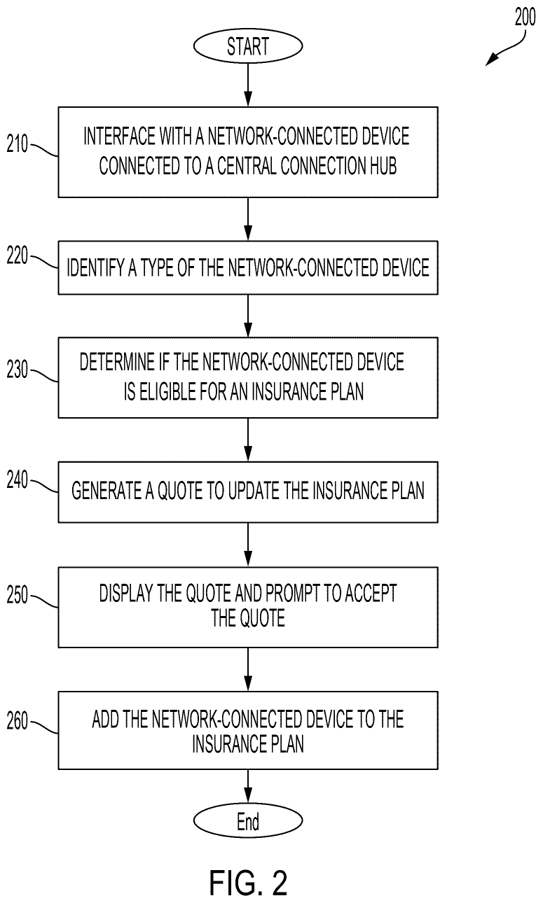

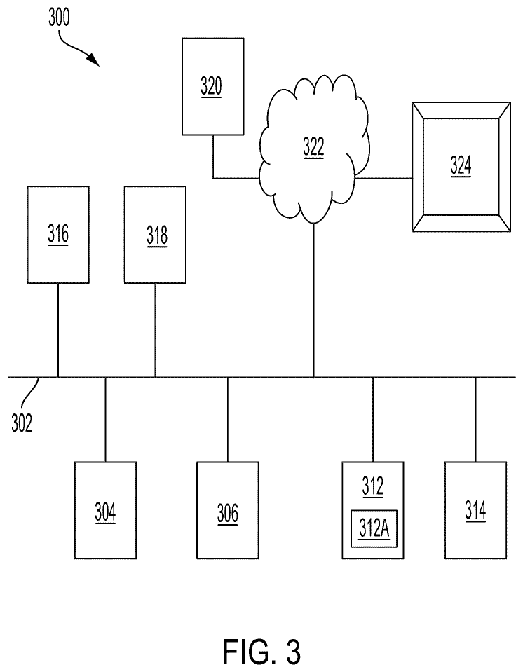

Referring to FIG. 2, an embodiment of a process 200 is shown for automatically generating quotes for adding a network-connected device to a circle of protection insurance plan via the environment 100 of FIG. 1 (as implemented by a system 300 of FIG. 3, described in greater detail below). In block 210, one or more network-connected devices associated with a controlling user entity are communicatively coupled to the central connection hub 110 of FIG. 1. In these embodiments, the network-connected devices interface with the central connection hub 110 automatically based on the network-connected devices connection to the central connection hub.

In block 220, the global device repository 120 of FIG. 1 communicatively coupled to the central connection hub 110 provides information to the central connection hub 110 that allows the central connection hub 110 to automatically identify a type of device of the network-connected device based on information from the global device repository 120. For example, the information provided by the global device repository 120 may allow the central connection hub 110 to determine if the network-connected device is a type of device such as a smart home device, an entertainment device, a personal device, a home appliance device, or any other similar type of device. In embodiments, identifying the type of network-connected device may further involve gathering device specific data, such as MAC address, IP address, manufacturer details, model numbers, and other specific data that provides additional insight on the type of network-connected device paired to the network.

In block 230, the machine learning-based determination module 130 of FIG. 1 and one or more connectivity rules are utilized to determine if a network-connected device is eligible for a circle of protection insurance plan for the one or more of network-connected devices associated with the controlling user entity. In these embodiments, determining the eligibility of any of the network-connected devices may further involve analyzing a condition of the network-connected device, as has been described herein with reference to FIG. 1. Furthermore, the determination module 130 may also be configured to ensure that the network-connected devices are associated with the controlling user entity. That is, the determination module 130 may automatically declare that any network-connected devices not associated with the controlling user entity is ineligible for the circle of protection insurance plan.

In embodiments, using the one or more connectivity rules, the determination module 130 is configured to determine whether the network-connected device is eligible for a new insurance plan (such as when a circle of protection plan may not currently exist and/or as a separate plan). Based on a determination that the network-connected device is eligible for the new insurance plan, the underwriting module 140 is configured to generate a new plan quote. Via the user interface of the mobile device, the new plan quote may be displayed along with a prompt to accept the new plan quote. Upon acceptance of the prompt to accept the new plan quote on the user interface of the mobile device, the network-connected device may be added to the new insurance plan. The new insurance plan may be updated to be the circle of protection plan, wherein the network-connected device is one of the one or more network-connected devices associated with the controlling user entity.

In embodiments, the one or more connectivity rules may include a finding of the network-connected device staying over a pre-defined period of time, a finding of registration of the network-connected device being registered to a user associated with the controlling user entity, a finding of a condition of the device exceeding a condition threshold, or combinations thereof.

As depicted at block 240, once the determination module 130 has determined the network-connected device being analyzed is eligible for the circle of protection insurance plan, an underwriting module 140 may be used to generate a quote to update the circle of protection insurance plan to include the eligible network-connected device. In these embodiments, it should be appreciated that the circle of protection plan may be continuously updated, in real time, whenever a new device associated with the controlling user entity is connected to the central connection hub 110 and determined to be eligible to be added to the circle of protection plan.

In block 250, the updated circle of protection insurance plan quote may be transmitted to a user via a user interface of a mobile device of the controlling user entity communicatively coupled to the automated discovery tool 150. In these embodiments, displaying the quote 160 via the user interface of the mobile device of the controlling user entity may further involve display via the user interface of a prompt for the user to accept the quote 160.

As depicted at block 260, upon acceptance of the prompt to accept the quote 160 on the user interface of the mobile device, the network-connected device may be added to the circle of protection insurance plan. The added network-connected device becomes one of the one or more network-connected devices associated with the controlling user entity. Once the network-connected device is added to the circle of protection insurance plan, central connection hub 110 may continuously monitor a monitored condition of each of the network-connected devices in real-time while each network-connected device is connected to the central connection hub, and provide the real-time condition information to the determination module 130. The monitored condition may be based on information received by one or more sensors of each network-connected device, such as to indicate a breakage of the device (such as a cracked smart phone screen). Such conditions may further be factors to determine the quote 160. In embodiments, a user may be required to submit a photograph of a device prior to receiving the quote 160 or after receiving the quote 160 and prior to being able to accept the quote 160 as a condition for eligibility. The determination module 130 may further utilize the real-time condition data and historical condition data to predict when the network-connected device may require maintenance. Furthermore, the monitored condition data may be utilized to update the quote 160 for the circle of protection insurance plan over time.

In embodiments, a user notification may be generated when the monitored condition of at least one of the one or more network-connected devices is below a loss threshold. The loss threshold is indicative of an occurrence of a loss event, which loss event may include, but not be limited to, damage to or total loss of the at least one network-connected event. Further, the monitored condition of each of the one or more network-connected devices may include respective information relating to at least one of an age, a physical condition, a price, or a usage pattern. The monitored condition may include historical data and real-time data related to condition information of each of the one or more network-connected devices. Additionally or alternatively, the automated discovery tool 150 communicatively coupled to the determination module 130 may be configured to predict that at least one of the one or more network-connected devices requires maintenance based on the monitored condition and generate a user notification to inform a user associated with the controlling user entity that the at least one of the one or more network-connected devices requires maintenance.

Referring now to FIG. 3, a computer implemented system 300 for use with the process 200 of FIG. 2 and the environment 100 of FIG. 1 is depicted. Referring to FIG. 3, a computer implemented system 300 is shown for implementing a computer and software-based method, such as directed by the environment 100 and the process 200, for generating and/or updating circle of protection insurance plans. The system 300 comprises a communication path 302, one or more processors 304, a non-transitory memory component 306, an automated discovery tool module 312, an eligibility determination sub-module 312A of the automated discovery tool module 312, a storage or database 314, a machine learning module 316, a network interface hardware 318, a network 322, a server 320, and a computing device 324 communicatively coupled to one or more GUIs. The automated discovery tool module 312 is communicatively coupled to the automated discovery tool 150 of FIG. 1, and the eligibility determination sub-module is communicatively coupled to the determination module 130 of FIG. 1. The various components of the system 300 and the interaction thereof will be described in detail below.

While only one server 320 and one computing device 324 are illustrated, the system 300 can comprise multiple servers containing one or more applications and computing devices. In some embodiments, the system 300 is implemented using a wide area network (WAN) or network 322, such as an intranet or the internet. The computing device 324 may include digital systems and other devices permitting connection to and navigation of the network. It is contemplated and within the scope of this disclosure that the computing device 324 may be a personal computer, a laptop device, a smart mobile device such as a smart phone or smart pad, or the like. Other system 300 variations allowing for communication between various geographically diverse components are possible. The lines depicted in FIG. 3 indicate communication rather than physical connections between the various components.

The system 300 comprises the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the intelligent system 300. As used herein, the term “communicatively coupled” means that coupled components are capable of exchanging data signals with one another such as, for example, electrical signals via conductive medium, electromagnetic signals via air, optical signals via optical waveguides, and the like.

The computer implemented system 300 of FIG. 3 also comprises the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

The illustrated system 300 further comprises the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor 304, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, as noted above, the system 300 comprises the display such as the GUI on a screen of the computing device 324 for providing visual output such as, for example, information, graphical reports, messages, or a combination thereof. The display on the screen of the computing device 324 is coupled to the communication path 302 and communicatively coupled to the processor 304. Accordingly, the communication path 302 communicatively couples the display to other modules of the intelligent system 300. The display can comprise any medium capable of transmitting an optical output such as, for example, a cathode ray tube, light emitting diodes, a liquid crystal display, a plasma display, or the like. Additionally, it is noted that the display or the computing device 324 can comprise at least one of the processor 304 and the memory component 306. While the system 300 is illustrated as a single, integrated system in FIG. 3, in other embodiments, the systems can be independent systems.

The system 300 comprises the automated discovery tool module 312 as described above to, in combination with the eligibility determination sub-module 312A, at least determine the eligibility of a network-connected device connected to a central connection hub 110 of a controlling user entity for inclusion in the circle of protection insurance plan for the controlling user entity, and to, in embodiments, further monitor the condition of each of the network-connected devices covered by the circle of protection plan to determine when at least one of the network-connected devices may require maintenance. The machine learning module 316 communicatively coupled to the automated discovery tool module 312 and the eligibility determination sub-module 312A may include an artificial intelligence component to train and provide machine learning capabilities to a neural network as described herein for intelligent adjustable price-per-metric rate determination.

The automated discovery tool module 312, the eligibility determination sub-module 312A, and the machine learning module 316 are coupled to the communication path 302 and communicatively coupled to the processor 304. As will be described in further detail below, the processor 304 may process the input signals received from the system modules and/or extract information from such signals.

Data stored and manipulated in the system 300 as described herein is utilized by the machine learning module 316, which is able to leverage a cloud computing-based network configuration such as the cloud to apply Machine Learning and Artificial Intelligence. This machine learning application may create models that can be applied by the system 300, to make it more efficient and intelligent in execution. As an example and not a limitation, the machine learning module 316 may include artificial intelligence components selected from the group consisting of an artificial intelligence engine, Bayesian inference engine, and a decision-making engine, and may have an adaptive learning engine further comprising a deep neural network learning engine.

The system 300 comprises the network interface hardware 318 for communicatively coupling the system 300 with a computer network such as network 322. The network interface hardware 318 is coupled to the communication path 302 such that the communication path 302 communicatively couples the network interface hardware 318 to other modules of the intelligent system 300. The network interface hardware 318 can be any device capable of transmitting and/or receiving data via a wireless network. Accordingly, the network interface hardware 318 can comprise a communication transceiver for sending and/or receiving data according to any wireless communication standard. For example, the network interface hardware 318 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computing device 324 can be provided from the computing device 324 to the system 300 via the network interface hardware 318. The computing device 324 can be any device having hardware (e.g., chipsets, processors, memory, etc.) for communicatively coupling with the network interface hardware 318 and a network 322. Specifically, the computing device 324 can comprise an input device having an antenna for communicating over one or more of the wireless computer networks described above.

The network 322 can comprise any wired and/or wireless network such as, for example, wide area networks, metropolitan area networks, the internet, an intranet, satellite networks, or the like. Accordingly, the network 322 can be utilized as a wireless access point by the computing device 324 to access one or more servers (e.g., a server 320). The server 320 and any additional servers generally comprise processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

The systems and methods as described herein are directed to an artificial intelligence (AI) based discovery hub system 300 of FIG. 3 as set forth in the environment 100 of FIG. 1 that combines a central connection hub 110, an automated discovery mechanism (e.g., automated discovery tool 150), machine learning based prediction and estimation, and an IoT data repository (e.g., global device repository 120) to automatically retrieve device information to determine eligibility for, estimate, and/or generate a circle of protection insurance plan to controlling user entities (such as households or businesses) with network connected devices and/or to automatically generate warning alerts associated with said network connected devices.

In some embodiments, the connected network devices may automatically appear in the discovery mechanism on, for example, an application downloaded on a smart mobile device or other platform, such that the devices may be viewed by a user of the platform. In embodiments, a machine learning based prediction and estimation model as described herein may analyze the devices identified by the wifi router (i.e., with a machine identification sent from the device to the wifi router upon connection), with information supplemented by the global IoT data repository (such as information based on the machine identification that may include, and not be limited to, age of the device, value, and the like) to provide a circle of protection estimate for insuring each of the devices connected to the household network, updating a current circle of protection plan, or the like. The system may determine whether the identified new device is even eligible for a circle of protection plan and, if so, what an estimate might be based on utilization of the machine learning model. The user may then purchase the circle of protection insurance through the discovery mechanism of the application as desired.

As described herein, the disclosed discovery mechanism may also be used to constantly monitor the state of all valuables and/or devices under the circle of protection plan and serve as an early warning system to minimize loss. For example, if a user has a network compatible refrigerator (or other similar device) in the circle of protection monitored, the system may be able to identify the occurrence of a leak (or other malfunction) and may notify a user (i.e., via the application and/or other notification platform) such that the issue may be avoided and/or remedied to minimize loss.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### ASPECTS LISTING

1. A system comprising: a central connection hub configured to be communicatively coupled to one or more network-connected devices associated with a controlling user entity; an automated discovery tool; a global device repository; one or more memory components; one or more processors, the central connection hub, the automated discovery tool, the global device repository, and the one or more memory units communicatively coupled to the one or more processors; and machine readable instructions stored in the one or more memory components that cause the system to perform at least the following when executed by the one or more processors: interface with a network-connected device via the central connection hub based on connection of the network-connected device to the central connection hub; identify a type of device of the network-connected device connected to the central connection hub automatically based on information from the global device repository; determine, using a machine learning-based determination module and one or more connectivity rules, whether the network-connected device is eligible for a circle of protection insurance plan for the one or more of network-connected devices associated with the controlling user entity; generate, using an underwriting module and based on a determination that the network-connected device is eligible for the circle of protection insurance plan, a quote to update the circle of protection plan to include the network-connected device; display, via a user interface of a mobile device of the controlling user entity communicatively coupled to the automated discovery tool, the quote and a prompt to accept the quote; and upon acceptance of the prompt to accept the quote on the user interface of the mobile device, add the network-connected device to the circle of protection plan, wherein the network-connected device becomes one of the one or more network-connected devices associated with the controlling user entity.
Aspect 2. The system of Aspect 1, wherein the machine readable instructions further cause the system to perform at least the following when executed by the one or more processors: determine, using the machine learning-based determination module and the one or more connectivity rules, whether the network-connected device is eligible for a new insurance plan; generate, using the underwriting module and based on a determination that the network-connected device is eligible for the new insurance plan, a new plan quote; display, via the user interface of the mobile device, the new plan quote and a prompt to accept the new plan quote; and upon acceptance of the prompt to accept the new plan quote on the user interface of the mobile device, add the network-connected device to the new insurance plan.
Aspect 3. The system of Aspect 2, wherein the machine readable instructions further cause the system to perform at least the following when executed by the one or more processors: update the new insurance plan to be the circle of protection plan, wherein the network-connected device is one of the one or more network-connected devices associated with the controlling user entity.
Aspect 4. The system of any of Aspect 1 to Aspect 3, wherein the one or more connectivity rules comprise a finding of the network-connected device staying over a pre-defined period of time, a finding of registration of the network-connected device being registered to a user associated with the controlling user entity, a finding of a condition of the device exceeding a condition threshold, or combinations thereof.
Aspect 5. The system of any of Aspect 1 to Aspect 4, wherein the machine readable instructions further cause the system to perform at least the following when executed by the one or more processors: monitor a monitored condition of each of the one or more network-connected devices in real-time while each network-connected device is connected to the central connection hub.
Aspect 6. The system of any of Aspect 5, wherein the machine readable instructions further cause the system to perform at least the following when executed by the one or more processors: generate a user notification when the monitored condition of at least one of the one or more network-connected devices is below a loss threshold, the loss threshold indicative of an occurrence of a loss event.
Aspect 7. The system of any of Aspect 1 to Aspect 6, wherein the monitored condition of each of the one or more network-connected devices comprises respective information relating to at least one of an age, a physical condition, a price, or a usage pattern.
Aspect 8. The system of any of Aspect 1 to Aspect 7, wherein the machine readable instructions further cause the system to perform at least the following when executed by the one or more processors: predict that at least one of the one or more network-connected devices requires maintenance based on the monitored condition; and generate a user notification to inform a user associated with the controlling user entity that the at least one of the one or more network-connected devices requires maintenance.
Aspect 9. The system of any of Aspect 1 to Aspect 8, wherein the monitored condition comprises historical data and real-time data related to condition information of each of the one or more network-connected devices.
Aspect 10. The system of any of Aspect 1 to Aspect 9, wherein the controlling user entity comprises a household or a business.
Aspect 11. A system comprising: a central connection hub configured to be communicatively coupled to one or more network-connected devices associated with a controlling user entity, wherein the controlling user entity is one of a household or a business; an automated discovery tool; a global device repository; one or more memory components; one or more processors, the central connection hub, the automated discovery tool, the global device repository, and the one or more memory units communicatively coupled to the one or more processors; and machine readable instructions stored in the one or more memory components that cause the system to perform at least the following when executed by the one or more processors: interface with a network-connected device via the central connection hub based on connection of the network-connected device to the central connection hub; identify a type of device of the network-connected device connected to the central connection hub automatically based on information from the global device repository; determine, using a machine learning-based determination module and one or more connectivity rules, whether the network-connected device is eligible for a circle of protection insurance plan for the one or more of network-connected devices associated with the controlling user entity; generate, using an underwriting module and based on a determination that the network-connected device is eligible for the circle of protection insurance plan, a quote to update the circle of protection plan to include the network-connected device; display, via a user interface of a mobile device of the controlling user entity communicatively coupled to the automated discovery tool, the quote and a prompt to accept the quote; upon acceptance of the prompt to accept the quote on the user interface of the mobile device, add the network-connected device to the circle of protection plan, wherein the network-connected device becomes one of the one or more network-connected devices associated with the controlling user entity; and monitor a monitored condition of each of the one or more network-connected devices in real-time while each network-connected device is connected to the central connection hub.
Aspect 12. The system of Aspect 11, wherein the machine readable instructions further cause the system to perform at least the following when executed by the one or more processors: determine, using the machine learning-based determination module and the one or more connectivity rules, whether the network-connected device is eligible for a new insurance plan; generate, using the underwriting module and based on a determination that the network-connected device is eligible for the new insurance plan, a new plan quote; display, via the user interface of the mobile device, the new plan quote and a prompt to accept the new plan quote; andupon acceptance of the prompt to accept the new plan quote on the user interface of the mobile device, add the network-connected device to the new insurance plan.
Aspect 13. The system of Aspect 12, wherein the machine readable instructions further cause the system to perform at least the following when executed by the one or more processors: update the new insurance plan to be the circle of protection plan, wherein the network-connected device is one of the one or more network-connected devices associated with the controlling user entity.
Aspect 14. The system of any of Aspect 11 to Aspect 13, wherein the one or more connectivity rules comprise a finding of the network-connected device staying over a pre-defined period of time, a finding of registration of the network-connected device being registered to a user associated with the controlling user entity, a finding of a condition of the device exceeding a condition threshold, or combinations thereof.
Aspect 15. The system of any of Aspect 11 to Aspect 14, wherein the machine readable instructions further cause the system to perform at least the following when executed by the one or more processors: generate a user notification when the monitored condition of at least one of the one or more network-connected devices is below a loss threshold, the loss threshold indicative of an occurrence of a loss event.
Aspect 16. The system of any of Aspect 11 to Aspect 15, wherein the monitored condition of each of the one or more network-connected devices comprises respective information relating to at least one of an age, a physical condition, a price, or a usage pattern.
Aspect 17. The system of any of Aspect 11 to Aspect 16, wherein the machine readable instructions further cause the system to perform at least the following when executed by the one or more processors: predict that at least one of the one or more network-connected devices requires maintenance based on the monitored condition; and generate a user notification to inform a user associated with the controlling user entity that the at least one of the one or more network-connected devices requires maintenance.
Aspect 18. The system of any of Aspect 11 to Aspect 17, wherein the monitored condition comprises historical data and real-time data related to condition information of each of the one or more network-connected devices.
Aspect 19. A method comprising: via a central connection hub configured to be communicatively coupled to one or more network-connected devices associated with a controlling user entity, interfacing with a network-connected device based on connection of the network-connected device to the central connection hub; identifying a type of device of the network-connected device connected to the central connection hub automatically based on information from a global device repository communicatively coupled to the central connection hub; determining, using a machine learning-based determination module and one or more connectivity rules, whether the network-connected device is eligible for a circle of protection insurance plan for the one or more of network-connected devices associated with the controlling user entity; generating, using an underwriting module and based on a determination that the network-connected device is eligible for the circle of protection insurance plan, a quote to update the circle of protection plan to include the network-connected device; displaying, via a user interface of a mobile device of the controlling user entity communicatively coupled to the automated discovery tool, the quote and a prompt to accept the quote; and upon acceptance of the prompt to accept the quote on the user interface of the mobile device, adding the network-connected device to the circle of protection plan, wherein the network-connected device becomes one of the one or more network-connected devices associated with the controlling user entity.
Aspect 20. The method of Aspect 19, further comprising: determining, using the machine learning-based determination module and the one or more connectivity rules, whether the network-connected device is eligible for a new insurance plan; generating, using the underwriting module and based on a determination that the network-connected device is eligible for the new insurance plan, a new plan quote; displaying, via the user interface of the mobile device, the new plan quote and a prompt to accept the new plan quote; upon acceptance of the prompt to accept the new plan quote on the user interface of the mobile device, adding the network-connected device to the new insurance plan; and update the new insurance plan to be the circle of protection plan, wherein the network-connected device is one of the one or more network-connected devices associated with the controlling user entity.

What is claimed is:

1. A system comprising:
a central connection hub configured to be communicatively coupled to one or more network-connected devices associated with a controlling user entity;
an automated discovery tool;
a global device repository;
one or more memory components;
one or more processors, the central connection hub, the automated discovery tool, the global device repository, and the one or more memory units communicatively coupled to the one or more processors; and
machine readable instructions stored in the one or more memory components that cause the system to perform at least the following when executed by the one or more processors:
interface with a network-connected device via the central connection hub based on connection of the network-connected device to the central connection hub;
identify a type of device of the network-connected device connected to the central connection hub automatically based on information from the global device repository;
determine, using a machine learning-based determination module and one or more connectivity rules, whether the network-connected device is eligible for a circle of protection insurance plan for the one or more of network-connected devices associated with the controlling user entity;
generate, using an underwriting module and based on a determination that the network-connected device is eligible for the circle of protection insurance plan, a quote to update the circle of protection plan to include the network-connected device;
display, via a user interface of a mobile device of the controlling user entity communicatively coupled to the automated discovery tool, the quote and a prompt to accept the quote; and
upon acceptance of the prompt to accept the quote on the user interface of the mobile device, add the network-connected device to the circle of protection plan, wherein the network-connected device becomes one of the one or more network-connected devices associated with the controlling user entity.

2. The system of claim 1, wherein the machine readable instructions further cause the system to perform at least the following when executed by the one or more processors:
determine, using the machine learning-based determination module and the one or more connectivity rules, whether the network-connected device is eligible for a new insurance plan;
generate, using the underwriting module and based on a determination that the network-connected device is eligible for the new insurance plan, a new plan quote;
display, via the user interface of the mobile device, the new plan quote and a prompt to accept the new plan quote; and
upon acceptance of the prompt to accept the new plan quote on the user interface of the mobile device, add the network-connected device to the new insurance plan.

3. The system of claim 2, wherein the machine readable instructions further cause the system to perform at least the following when executed by the one or more processors:
update the new insurance plan to be the circle of protection plan, wherein the network-connected device is one of the one or more network-connected devices associated with the controlling user entity.

4. The system of claim 1, wherein the one or more connectivity rules comprise a finding of the network-connected device staying over a pre-defined period of time, a finding of registration of the network-connected device being registered to a user associated with the controlling user entity, a finding of a condition of the device exceeding a condition threshold, or combinations thereof.

5. The system of claim 1, wherein the machine readable instructions further cause the system to perform at least the following when executed by the one or more processors:
monitor a monitored condition of each of the one or more network-connected devices in real-time while each network-connected device is connected to the central connection hub.

6. The system of claim 5, wherein the machine readable instructions further cause the system to perform at least the following when executed by the one or more processors:
generate a user notification when the monitored condition of at least one of the one or more network-connected devices is below a loss threshold, the loss threshold indicative of an occurrence of a loss event.

7. The system of claim 5, wherein the monitored condition of each of the one or more network-connected devices comprises respective information relating to at least one of an age, a physical condition, a price, or a usage pattern.

8. The system of claim 5, wherein the machine readable instructions further cause the system to perform at least the following when executed by the one or more processors:
predict that at least one of the one or more network-connected devices requires maintenance based on the monitored condition; and
generate a user notification to inform a user associated with the controlling user entity that the at least one of the one or more network-connected devices requires maintenance.

9. The system of claim 5, wherein the monitored condition comprises historical data and real-time data related to condition information of each of the one or more network-connected devices.

10. The system of claim 1, wherein the controlling user entity comprises a household or a business.

11. A system comprising:
a central connection hub configured to be communicatively coupled to one or more network-connected devices associated with a controlling user entity, wherein the controlling user entity is one of a household or a business;
an automated discovery tool;
a global device repository;
one or more memory components;
one or more processors, the central connection hub, the automated discovery tool, the global device repository, and the one or more memory units communicatively coupled to the one or more processors; and
machine readable instructions stored in the one or more memory components that cause the system to perform at least the following when executed by the one or more processors:
interface with a network-connected device via the central connection hub based on connection of the network-connected device to the central connection hub;
identify a type of device of the network-connected device connected to the central connection hub automatically based on information from the global device repository;
determine, using a machine learning-based determination module and one or more connectivity rules, whether the network-connected device is eligible for a circle of protection insurance plan for the one or more of network-connected devices associated with the controlling user entity;
generate, using an underwriting module and based on a determination that the network-connected device is eligible for the circle of protection insurance plan, a quote to update the circle of protection plan to include the network-connected device;
display, via a user interface of a mobile device of the controlling user entity communicatively coupled to the automated discovery tool, the quote and a prompt to accept the quote;
upon acceptance of the prompt to accept the quote on the user interface of the mobile device, add the network-connected device to the circle of protection plan, wherein the network-connected device becomes one of the one or more network-connected devices associated with the controlling user entity; and
monitor a monitored condition of each of the one or more network-connected devices in real-time while each network-connected device is connected to the central connection hub.

12. The system of claim 11, wherein the machine readable instructions further cause the system to perform at least the following when executed by the one or more processors:
determine, using the machine learning-based determination module and the one or more connectivity rules, whether the network-connected device is eligible for a new insurance plan;
generate, using the underwriting module and based on a determination that the network-connected device is eligible for the new insurance plan, a new plan quote;
display, via the user interface of the mobile device, the new plan quote and a prompt to accept the new plan quote; and
upon acceptance of the prompt to accept the new plan quote on the user interface of the mobile device, add the network-connected device to the new insurance plan.

13. The system of claim 12, wherein the machine readable instructions further cause the system to perform at least the following when executed by the one or more processors:
update the new insurance plan to be the circle of protection plan, wherein the network-connected device is one of the one or more network-connected devices associated with the controlling user entity.

14. The system of claim 11, wherein the one or more connectivity rules comprise a finding of the network-connected device staying over a pre-defined period of time, a finding of registration of the network-connected device being registered to a user associated with the controlling user entity, a finding of a condition of the device exceeding a condition threshold, or combinations thereof.

15. The system of claim 11, wherein the machine readable instructions further cause the system to perform at least the following when executed by the one or more processors:
generate a user notification when the monitored condition of at least one of the one or more network-connected devices is below a loss threshold, the loss threshold indicative of an occurrence of a loss event.

16. The system of claim 11, wherein the monitored condition of each of the one or more network-connected devices comprises respective information relating to at least one of an age, a physical condition, a price, or a usage pattern.

17. The system of claim 11, wherein the machine readable instructions further cause the system to perform at least the following when executed by the one or more processors:
predict that at least one of the one or more network-connected devices requires maintenance based on the monitored condition; and
generate a user notification to inform a user associated with the controlling user entity that the at least one of the one or more network-connected devices requires maintenance.

18. The system of claim 11, wherein the monitored condition comprises historical data and real-time data related to condition information of each of the one or more network-connected devices.

19. A method comprising:
via a central connection hub configured to be communicatively coupled to one or more network-connected devices associated with a controlling user entity, interfacing with a network-connected device based on connection of the network-connected device to the central connection hub;
identifying a type of device of the network-connected device connected to the central connection hub automatically based on information from a global device repository communicatively coupled to the central connection hub;
determining, using a machine learning-based determination module and one or more connectivity rules, whether the network-connected device is eligible for a circle of protection insurance plan for the one or more of network-connected devices associated with the controlling user entity;
generating, using an underwriting module and based on a determination that the network-connected device is eligible for the circle of protection insurance plan, a quote to update the circle of protection plan to include the network-connected device;
displaying, via a user interface of a mobile device of the controlling user entity communicatively coupled to the automated discovery tool, the quote and a prompt to accept the quote; and
upon acceptance of the prompt to accept the quote on the user interface of the mobile device, adding the network-connected device to the circle of protection plan, wherein the network-connected device becomes one of the one or more network-connected devices associated with the controlling user entity.

20. The method of claim 19, further comprising:
determining, using the machine learning-based determination module and the one or more connectivity rules, whether the network-connected device is eligible for a new insurance plan;
generating, using the underwriting module and based on a determination that the network-connected device is eligible for the new insurance plan, a new plan quote;
displaying, via the user interface of the mobile device, the new plan quote and a prompt to accept the new plan quote;
upon acceptance of the prompt to accept the new plan quote on the user interface of the mobile device, adding the network-connected device to the new insurance plan; and
update the new insurance plan to be the circle of protection plan, wherein the network-connected device is one of the one or more network-connected devices associated with the controlling user entity.
